(19) United States
(12) Patent Application Publication
(10) Pub. No.: US 2014/0020697 A1
(43) Pub. Date: Jan. 23, 2014

(54) Electronic Cigarette Case and Electronic Cigarette Device

(71) Applicant: Qiuming Liu, Shenzhen City (CN)

(72) Inventor: Qiuming Liu, Shenzhen City (CN)

(21) Appl. No.: 13/816,934

(22) PCT Filed: Jul. 23, 2012
(86) PCT No.: PCT/CN12/79039

§ 371 Date: Feb. 13, 2013

(51) Int. Cl. A24F 15/00; H02J 7/02

(52) U.S. Cl. CPC A24F 15/00; H02J 7/025
USPC 131/329; 320/108

(57) ABSTRACT

This invention relates to a wireless charging electronic cigarette case and an electronic cigarette device. The electronic cigarette case comprises a case body to accommodate at least one electronic cigarette, a wireless charging transmitter disposed in the case body, and a first rechargeable battery disposed in the case body to supply power for the wireless charging transmitter. The wireless charging transmitter comprises a transmitting unit to transmit electromagnetic signals, a display unit electrically connected with the first rechargeable battery to test, measure and display quantity of electricity of the first rechargeable battery, and a first circuit processing module electrically connected with the transmitting unit, the display unit and the first rechargeable battery. An electronic cigarette case of the present invention has advantages of convenient use and providing functions of displaying quantity of electricity of rechargeable batteries of the electronic cigarette case and charging multiple electronic cigarettes simultaneously.

### TECHNICAL FIELD

The present invention relates to a technical area of an electronic cigarette and an electronic cigarette case, and especially to an electronic cigarette device with a wireless charging function.

### DESCRIPTION OF BACKGROUND

Currently, electronic cigarette cases available in the market generally recharge electronic cigarettes via specialized built-in charging sockets. Since the electronic cigarettes respectively comprises inhaling rods and power rods both of which are connected threadedly, the power rods is necessary to be threadedly connected and fixed to the charging sockets of the electronic cigarette cases in order to be recharged after the power rods are untwisted away from the inhaling rods and are inserted into the electronic cigarette cases. Because tight twisting of the power rods is necessary for recharging, its recharging operation is inconvenient and time consuming Moreover, such electronic cigarette cases are unable to display quantity of electricity of their inner rechargeable battery.

### SUMMARY

An object of the present invention is to provide an electronic cigarette case. The electronic cigarette case is convenient to be used and is able to display quantity of electricity of a rechargeable battery of the electronic cigarette case. Moreover, multiple electronic cigarettes can be recharged simultaneously therein.

To achieve the above objects, the present invention provides an electronic cigarette case comprising a case body for accommodating at least one electronic cigarette, a wireless charging transmitter disposed in the case body, and a first rechargeable battery disposed in the case body and used to supply power for the wireless charging transmitter. Among them, the wireless charging transmitter comprises a transmitting unit for transmitting electromagnetic signals, a display unit electrically connected with the first rechargeable battery for testing, measuring and displaying quantity of electricity of the first rechargeable battery, and a first circuit processing module electrically connected with the transmitting unit, the display unit and the first rechargeable battery. The first rechargeable battery inputs direct electrical currents turned by the first circuit processing module via voltage-transforming and tuning to the transmitting unit for transmitting wireless charging electromagnetic signals therefrom. A display window of the display unit is disposed on an outer sidewall of the case body and the transmitting unit is disposed at a bottom wall of the case body.

Furthermore, the transmitting unit is a magnetic induction transmitting coil.

Furthermore, the wireless charging transmitter further comprises a transmitter circuit board. The first circuit processing module and the display unit both are integrated on the transmitter circuit board.

Furthermore, the wireless charging transmitter is accommodated in the electronic cigarette case via a first frame.

Furthermore, the transmitting unit is clippingly held and fixed between a bottom wall of the first frame and a bottom wall of the cigarette case.

Furthermore, the first rechargeable battery is installed in the first frame. A battery connector is further disposed in the first frame for electrically connecting with the first rechargeable battery and the transmitter circuit board.

Furthermore, a charging base comprises a first electrode piece and a second electrode piece respectively electrically connecting with a first electrode and a second electrode of the at least one electronic cigarette. The first electrode piece and the second electrode piece respectively electrically connect with a first electrode and a second electrode of the first rechargeable battery.

Furthermore, the first circuit processing module comprises a transmitter circuit unit to turn direct electrical currents of the first rechargeable battery into electrical currents required by the transmitting unit via voltage-transforming and tuning, a first charging circuit unit for recharging the first rechargeable battery, and a first electronic switch to initiate the wireless charging transmitter to work automatically after the transmitting unit is induced electrically and generates charging triggering electromagnetic signals.

Furthermore, the wireless charging transmitter further comprises an external power socket for insertedly connecting with an external power, the external power socket is electrically connected with the first charging circuit unit and is also integrated on the transmitter circuit board.

Furthermore, the electronic cigarette case further comprises a switch device. Among them, the switch device comprises a key installed at the case body and a control button correspondingly disposed on the transmitter circuit board. The key is capable of being pressed and controlled to electrically conduct with the transmitter circuit board so as to control the display unit to display quantity of electricity of the first rechargeable battery.

The present invention further provides an electronic cigarette device comprising the above-mentioned electronic cigarette case and at least one electronic cigarette accommodated in the electronic cigarette case. Each of the at least one electronic cigarette comprises a second rechargeable battery, and a wireless charging receiver matching with the wireless charging transmitter for recharging the second rechargeable battery.

Furthermore, the wireless charging receiver comprises a reception unit for inducing with the transmitting unit to make the transmitting unit generating charging triggering electromagnetic signals therein and for receiving wireless charging electromagnetic signals, a receiving conversion circuit unit used for converting the wireless charging electromagnetic signals received from the reception unit into electrical currents, and a second charging circuit unit for electrically connecting with the second rechargeable battery to recharge the second rechargeable battery.

Furthermore, the reception unit is a magnetic induction reception coil. The reception unit is inserted in the cigarette case and is relatively parallel to the transmitting unit.

Furthermore, an area of the reception unit is smaller than an area of the transmitting unit, and an orthogonal projection area of the reception unit falls within a range of the transmitting unit.

Furthermore, the at least one electronic cigarette comprises an inhaling rod and a power rod. The wireless charging receiver is disposed in the power rod, a bottom of the power rod comprises a bottom cover and the wireless charging receiver is fixed in the bottom cover.

Since the electronic cigarette case of the present invention comprises a wireless charging transmitter, it is convenient for use to recharge electronic cigarettes therein. Besides, a display unit is disposed at the electronic cigarette case to be able to display quantity of electricity of batteries of the electronic cigarette case, and multiple electronic cigarettes inserted into the electronic cigarette case can be recharged simultaneously.

Embodiments of the present invention are further described in detail in cooperation with drawings as follows.

### DESCRIPTION OF THE DRAWINGS

FIG. 1 is an elevational view of an electronic cigarette case in accordance with an embodiment of the present invention.

FIG. 2 is an exploded perspective view of the electronic cigarette case in accordance with an embodiment of the present invention.

FIG. 3 is the first cross-sectional view of the electronic cigarette case in accordance with an embodiment of the present invention.

FIG. 4 is the second cross-sectional view of the electronic cigarette case in accordance with an embodiment of the present invention.

FIG. 5 is a perspective view of an electronic cigarette in accordance with an embodiment of the present invention.

FIG. 6 is an exploded perspective view of a power rod of the electronic cigarette in accordance with an embodiment of the present invention.

FIG. 7 is a schematic diagram of a circuit structure of the electronic cigarette case in accordance with an embodiment of the present invention.

### DETAILED DESCRIPTION OF THE EMBODIMENTS

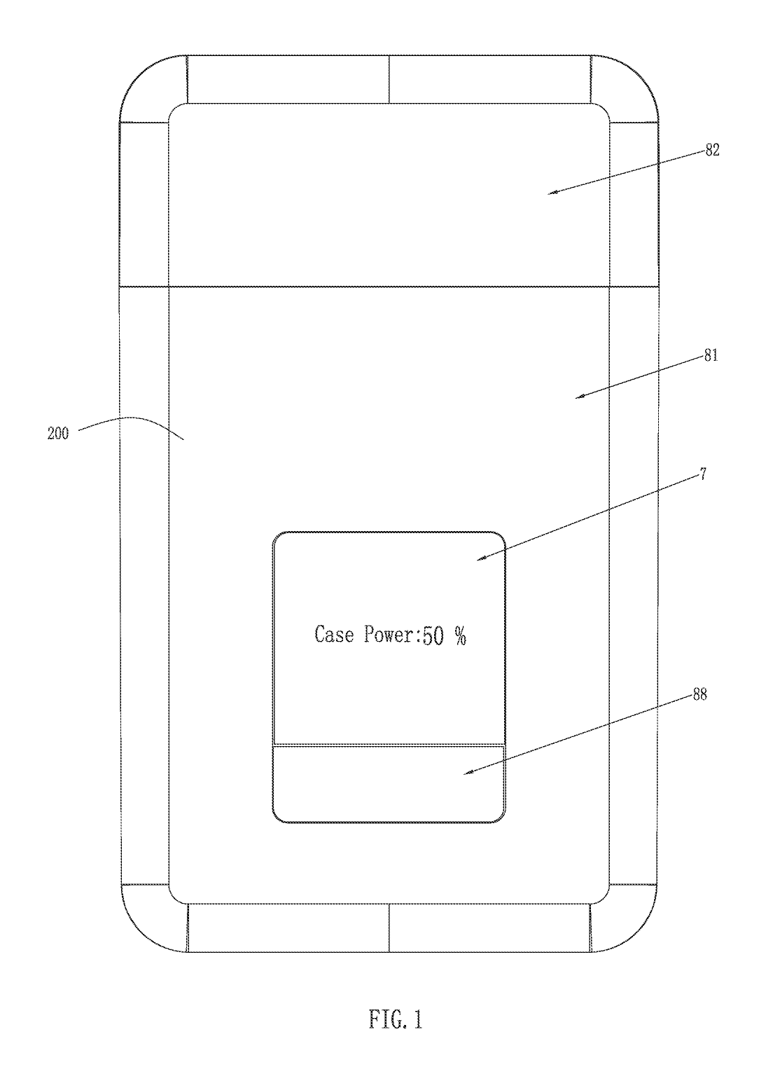

As shown in FIGS. 1-7, an electronic cigarette device with a wireless charging function is provided in accordance with an embodiment of the present invention. The electronic cigarette device comprises an electronic cigarette case 200 and at least one electronic cigarette 100. Each of the at least one electronic cigarette 100 comprises an inhaling rod 90 and a power rod 91.

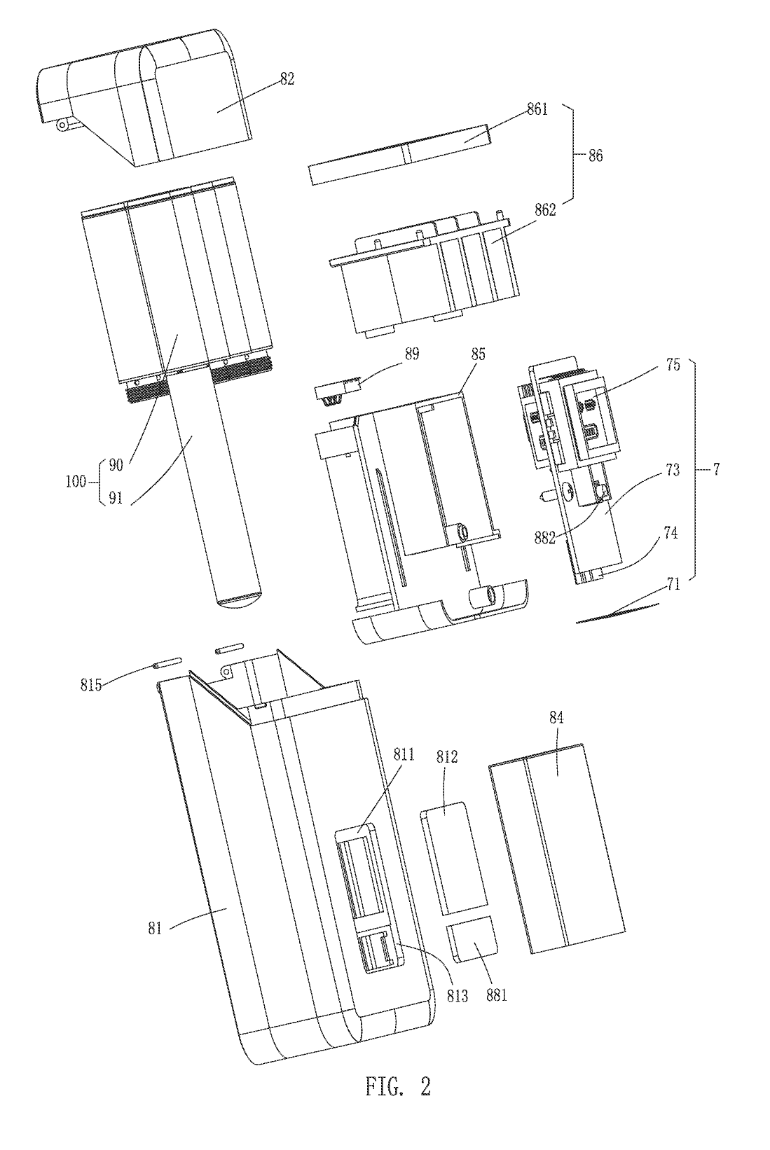

As shown in FIG. 2, the case 200 comprises a case body for accommodating the at least one electronic cigarette 100. The case body comprises and disposes therein a wireless charging transmitter 7 and a first rechargeable battery 84 to supply power for the wireless charging transmitter 7. In this embodiment, along a depicting orientation as shown in FIG. 2, the case body comprises a bottom case 81 and a case cover 82 to pivotally connect to and cover on the bottom case 81.

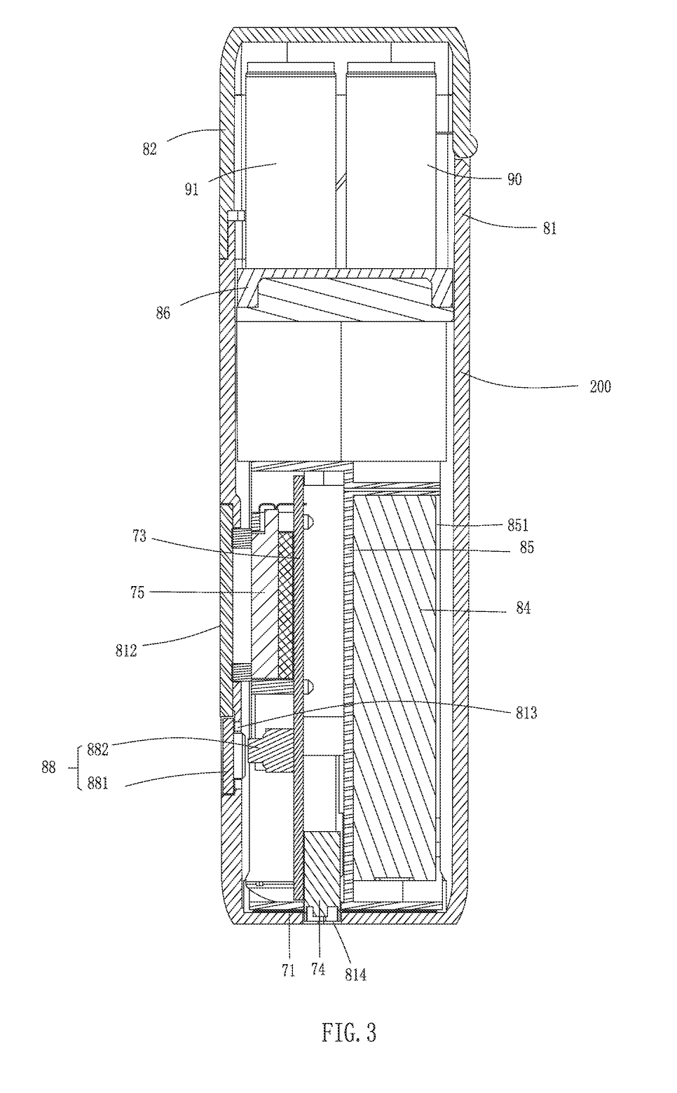

As shown in FIGS. 2-4, the bottom case 81 is a rectangle casing, certainly, the shape of the bottom case 81 does not limit to a rectangle, and can be shaped as, for example, a circle, an ellipse, or a polygon, etc. as long as the shape thereof matches with the case cover 82. The bottom case 81 comprises and disposes therein a first frame 85 to accommodate the first rechargeable battery 84, a second frame 86 to clippingly hold and support the at least one electronic cigarette 100, a switch device 88 and an electrode connector 89. The bottom case 81 further comprises and disposes thereon a viewing aperture 811, a display window 812 used to cover the viewing aperture 811, a key hole 813 (as shown in FIG. 2), an external power inserting hole 814 (as shown in FIG. 3) and a pivot 815 to make the case cover 82 pivotally connecting with and covering on the bottom case 81 (as shown in FIG. 2).

The first frame 85 is fixed in the bottom case 81 and comprises and disposed therein a containing trough 851 to fixedly accommodate the wireless charging transmitter 7 therein. The first frame 85 is made of metal or plastic material.

The second frame 86 is fixed in the bottom case 81 and is located above the first frame 85 to clippingly hold and support the at least one electronic cigarette 100. The second frame 86 is made of flexible plastic material. The second frame 86 further comprises a positioning plate 861 having a guiding hole to match with the at least one electronic cigarette 100, and a positioning shelf 862 to match with the positioning plate 861. The positioning plate 861 is placed above the positioning shelf 862 and is fixedly connected therewith in order to support and clippingly hold the at least one electronic cigarette 100 commonly. In this embodiment, the second frame 86 comprises eight holding holes (not shown). Therefore, after the first frame 85 and the second frame 86 are assembled together, the cigarette case 200 is capable of accommodating two assembled electronic cigarettes 100 and six cartridges.

As shown in FIGS. 2-3, the switch device 88 comprises a key 881 installed in the key hole 813 and disposed at a sidewall of the bottom case 81, and a control button 882 disposed on the wireless charging transmitter 7 and correspondingly matching with the key 881. In this embodiment, the control button 882 is integrated on a transmitter circuit board 73 of the wireless charging transmitter 7 to be described hereinafter to control a display unit 75 to be described hereinafter displaying data.

As shown in FIG. 2, the battery connector 89 comprises an elastically deformable positive electrode piece and negative electrode piece used to enable the first rechargeable battery 84 to correspondingly connect with a positive electrode and a negative electrode of the transmitter circuit board 73 of the wireless charging transmitter 7. The battery connector 89 is installed on the first frame 85.

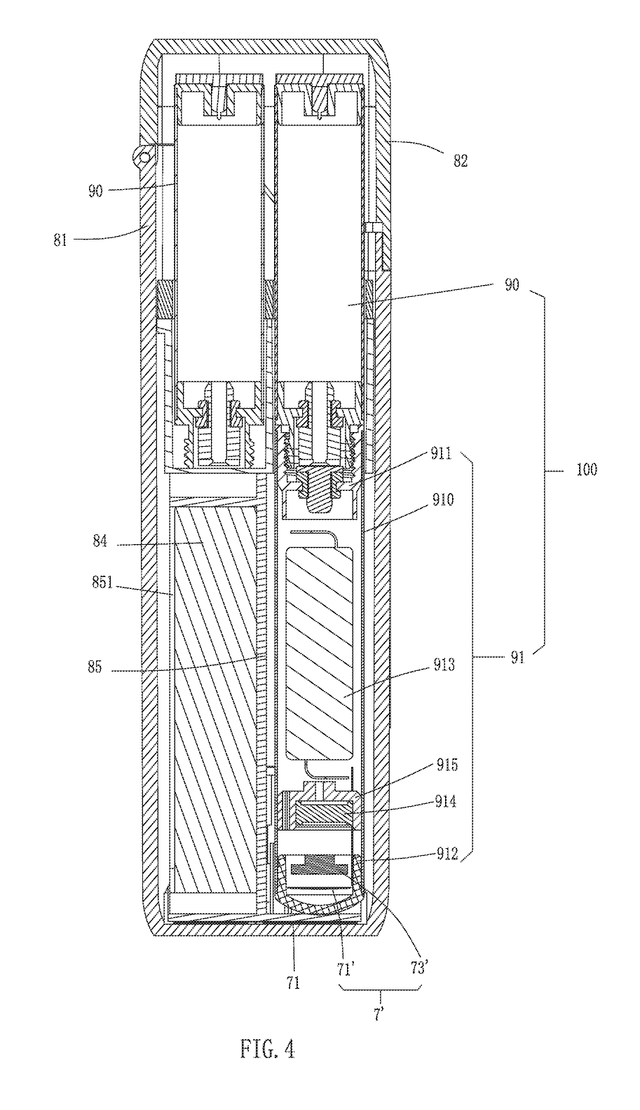

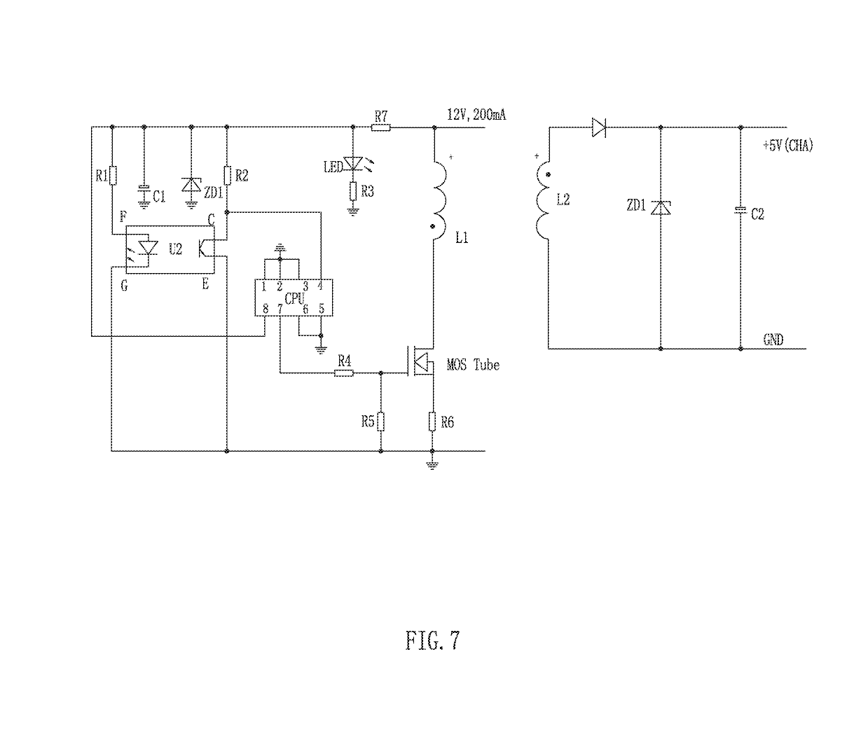

As shown in FIG. 3, the wireless charging transmitter 7 is disposed in the bottom case 81 and used to transmit electromagnetic wave signals. The wireless charging transmitter 7 comprises a transmitting unit 71 and a first circuit processing module electrically connected with the transmitting unit 71. The first circuit processing module is also electrically connected with the first rechargeable battery 84. In this embodiment, the transmitting unit 71 is a magnetic induction transmitting coil (Referring to “L1” as shown in FIG. 7), and is capable of generating electromagnetic signals during work. Further in this embodiment, the transmitting unit 71 is disposed at an inner wall of a bottom of the bottom case 81, and is clippingly held and fixed between a bottom wall of the first frame 85 and a bottom wall of the cigarette case 200 (as shown in FIGS. 3 and 4). An area of the transmitting unit 71 almost entirely covers the bottom wall of the cigarette case 200 to ensure that the two power rods 91 inserted in the cigarette case can receive wireless charging electromagnetic signals in a better location thereof to achieve the purpose of recharging the two electronic cigarettes simultaneously. Understandably, if it is allowed due to the capacity of the cigarette case, an area of the transmitting unit 1 can be adjusted correspondingly according to an area of the cigarette case so as to achieve the purpose of recharging multiple electronic cigarettes simultaneously. The first circuit processing module comprises a transmitter circuit unit to turn direct electrical currents of the first rechargeable battery 84 into electrical currents and voltages required by the transmitting unit via voltage-transforming and tuning, a charging circuit unit to recharge the first rechargeable battery 84, and a first electronic switch (such as a MOS tube as shown in FIG.) for sensing electromagnetic signals in order to initiate the wireless charging transmitter 7 to work. The wireless charging transmitter 7 further comprises a transmitter circuit board 73, an external power socket 74 for insertedly electrically connecting with an external power and a display unit 75 used for showing quantity of electricity of the first rechargeable battery 84 and the at least one electronic cigarette 100. The external power socket 74 and the first circuit processing module are integrated on the transmitter circuit board 73 and the transmitter circuit board 73 is fixed on the first frame 85. The external power socket 74 is electrically connected with the charging circuit unit. When power of the first rechargeable battery 84 is used up, the external power socket 74 is used to connect with the external power in order to recharge the first rechargeable battery 84. The external power socket 74 is installed in the external power inserting hole 814 during assembly. The display unit 75 (such as U2 as shown in FIG. 7) is used to test, measure and display quantity of electricity of the first rechargeable battery 84, and comprises a display part (F-G) and a testing and measuring part (C-E). As shown in FIG. 7, the part C-E is used to test and measure the quantity of electricity of the first rechargeable battery 84 and the part F-G is used to display its result. The display unit 75 is fixed on the transmitter circuit board 73, and a display screen thereof correspondingly faces and fits with the viewing aperture 811 to be disposed under the display window 812. Data on the display screen can be accordingly viewed through the display window 812. A partition plate is disposed between the display unit 75 and the transmitter circuit board 73 during installation. In use, quantity of electricity of the first rechargeable battery 84 is displayed on the display unit 75 after the key 881 is pressed. Certainly, control modes of the key 881 can be defined differently. The electronic cigarette case in accordance with the present invention has an additive function of being capable of displaying quantity of electricity of the first rechargeable battery 84 and the at least one electronic cigarette 100. It has advantages of being easy to operate and convenient, and of practical use.

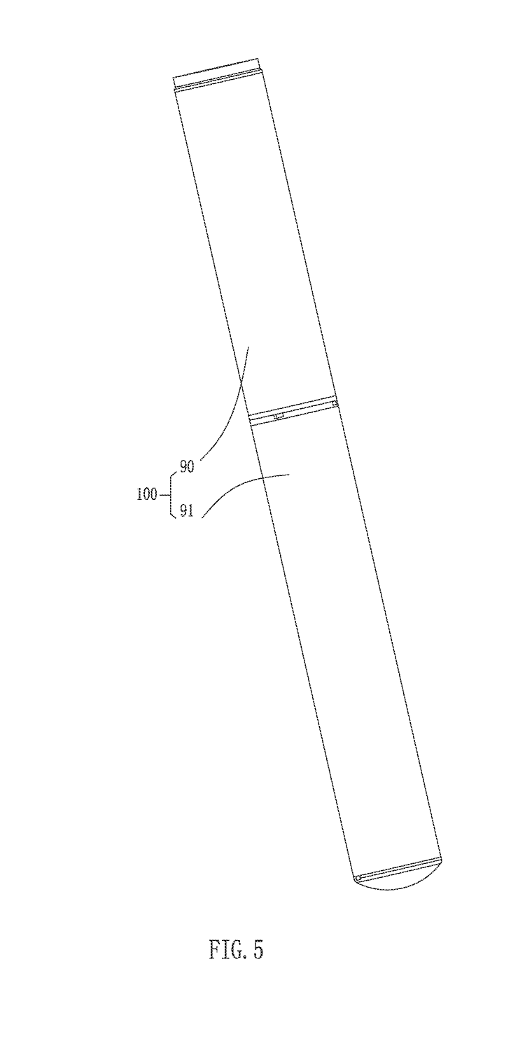

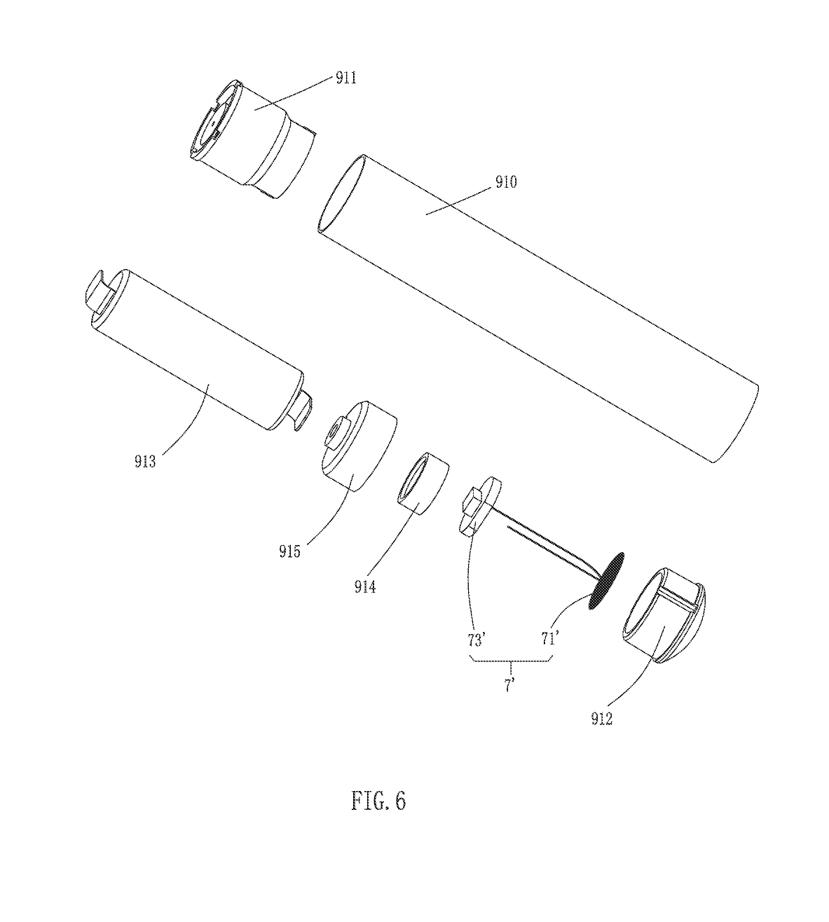

As shown in FIGS. 5-6, each of the at least one electronic cigarette 100 comprises the inhaling rod 90, the power rod 91 and a wireless charging receiver 7′. The inhaling rod 90 and the power rod 91 of each of the at least one electronic cigarette 100 can be connected by engaging fitting, insertion fitting or threaded connection. In this embodiment, the inhaling rod 90 and the power rod 91 are connected by screw threaded connection. The wireless charging transmitter 7′ is installed in the power rod 91, and certainly, the wireless charging transmitter 7 can be alternatively installed in the inhaling rod 90.

Smoke liquid is stored in the inhaling rod 90 in advance. The inhaling rod 90 comprises an atomizer to atomize smoke liquid and turn the smoke liquid into smoke, and an atomizer control circuit board (not shown).

The power rod 91 comprises a sleeve 910, a connecting element 911, a bottom cover 912, a second rechargeable battery 913, an atomizer switch 914, and a switch base 915. The connecting element 911 and the bottom cover 912 are respectively disposed at two ends of the sleeve 910. The second rechargeable battery 913 supplies power for the at least one electronic cigarette 100. The atomizer switch 914 is fixed in the switch base 915, and the switch base 915 is fixed in the sleeve 910. The atomizer switch 914 is electrically connected with the atomizer control circuit board for controlling the atomizer to initiate to atomize the smoke liquid stored therein and turn the smoke liquid into smoke.

The wireless charging receiver 7′ is disposed in the power rod 91, and is used to induce electromagnetic signals transmitted from the wireless charging transmitter 7 and to generate electrical currents to recharge the second rechargeable battery 913. In this embodiment, the wireless charging receiver 7′ is disposed at a bottom of the sleeve 910 and fixed therein via the bottom cover 912. The wireless charging transmitter 7′ comprises a reception unit 71′, a receiving conversion circuit unit used for converting wireless charging electromagnetic signals received from the reception unit into electrical currents, a second charging circuit unit used to recharge the second rechargeable battery, and a receiver circuit board 73′. The reception unit 71′ is used to induce with the transmitting unit 71 to make the transmitting unit 71 generating charging triggering electromagnetic signals, and to receive wireless charging electromagnetic signals. The reception unit 71′ is electrically connected with the receiving conversion circuit unit, and the second charging circuit processing unit is connected with the second rechargeable battery 913. In this embodiment, the reception unit 71 is a magnetic induction reception coil (i.e., L2 as shown in FIG. 7), and is electrically connected with the receiver circuit board 73′. In this embodiment, the reception unit 71′ is disposed at a bottom of the power rod 91 and is fixed in the bottom cover 917. Installation angles and orientations of the reception unit 71′ correspondingly match with the transmitting unit. In this embodiment, the magnetic induction reception coil is relatively parallel to the magnetic induction transmitting coil after the power rod 91 is inserted into the cigarette case 200. An area of the magnetic induction reception coil is smaller than the magnetic induction transmitting coil and an orthogonal projection area of the magnetic induction reception coil falls within a range of the magnetic induction transmitting coil. The magnetic induction transmitting coil of this embodiment is capable of ensuring simultaneously recharge of a plurality of the power rods 91 inserted in the cigarette case 200. Meanwhile, an orthogonal projection area of each of the plurality of magnetic induction reception coils completely falls within the range of the magnetic induction transmitting coil. The magnetic induction reception coil is fixed in the bottom cover 912 so as to conveniently and more effectively receive wireless charging electromagnetic signals transmitted from the magnetic induction transmitting coil (as shown in FIG. 4). The receiving conversion circuit unit and the second charging circuit unit are integrated on the receiver circuit board 73′, and the receiver circuit board 73′ is disposed at a bottom of the power rod 91. Understandably, the receiving conversion circuit unit and the second charging circuit unit also can be integrated on the atomizer control circuit board of the electronic cigarettes 100.

Working principles of an electronic cigarette device are described as follows. Since the reception unit 71′ of the wireless charging receiver 7′ is disposed inside the at least one electronic cigarette 100, the reception unit 71′ approaches the transmitting unit 71 to cause the transmitting unit 71 and the reception unit 71′ initiating electromagnetic induction therebetween, and the first electronic switch is triggered for electrical connection by induction electrical currents generated by the transmitting unit 71 when the power rod 91 is inserted into the cigarette case 200. Afterwards, the first circuit processing module controls the transmitter circuit processing unit to transform and tune so as to acquire voltages and electrical currents needed by the transmitting unit 71. The transmitting unit 71 therefore initiates its work to transmit electromagnetic signals. The reception unit 71′ of the at least one electronic cigarette 100 is capable of automatically inducing and receiving electromagnetic signals transmitted from the transmitting unit 71 of the wireless charging transmitter 7, then the receiving conversion circuit disposed on the receiver circuit board 73′ receives the electromagnetic signals and converts the signals into electrical currents, and finally the second rechargeable battery 913 is recharged via the second charging circuit unit. It is convenient to recharge without disassembling the inhaling rod 90 and the power rod 91 during the entire process as above mentioned. When the quantity of electricity of the first rechargeable battery 84 is need to be displayed, it simply needs either insertion of the at least one electronic cigarette 100 or pressing on the key 881 to make the display unit 75 displaying the quantity of electricity of the first rechargeable battery 84.

Understandably, the at least one electronic cigarettes 100 of this invention can be made as an integrated whole, in other words, the inhaling rod 90 and the sleeve 910 of the power rod 91 are made as an integral casing.

The above mentioned is only exemplary embodiments of the present invention. It should be noted, for persons of ordinary skill in this art field, improvements and modifications within the spirit and principle of the present invention can be further made, and such improvements and modifications should be seemed to be included in the claimed scope of the present invention.

1. An electronic cigarette case, comprising: An electronic cigarette case, comprising:
a case body for accommodating at least one electronic cigarette;
a wireless charging transmitter disposed in the case body; and
a first rechargeable battery disposed in the case body and used to supply power for the wireless charging transmitter;
wherein the wireless charging transmitter comprises:
a transmitting unit for transmitting electromagnetic signals;
a display unit electrically connected with the first rechargeable battery for testing, measuring and displaying quantity of electricity of the first rechargeable battery; and
a first circuit processing module electrically connected with the transmitting unit, the display unit and the first rechargeable battery;
the first rechargeable battery inputting direct electrical currents turned by the first circuit processing module via voltage-transforming and tuning to the transmitting unit for transmitting wireless charging electromagnetic signals therefrom, a display window of the display unit disposed on an outer sidewall of the case body, and the transmitting unit disposed at a bottom wall of the case body.

2. The electronic cigarette case as claimed in claim 1, wherein the transmitting unit is a magnetic induction transmitting coil.

3. The electronic cigarette case as claimed in claim 2, wherein the wireless charging transmitter further comprises a transmitter circuit board, the first circuit processing module and the display unit are both integrated on the transmitter circuit board.

4. The electronic cigarette case as claimed in claim 3, wherein the wireless charging transmitter is accommodated in the electronic cigarette case via a first frame.

5. The electronic cigarette case as claimed in claim 4, wherein the transmitting unit is clippingly held and fixed between a bottom wall of the first frame and the bottom wall of the case body.

6. The electronic cigarette case as claimed in claim 4, wherein the first rechargeable battery is installed in the first frame, a battery connector is further disposed in the first frame for electrically connecting with the first rechargeable battery and the transmitter circuit board.

7. (canceled)

8. The electronic cigarette case as claimed in claim 4, wherein the first circuit processing module comprises a transmitter circuit unit to turn direct electrical currents of the first rechargeable battery into electrical currents required by the transmitting unit via voltage-transforming and tuning, a first charging circuit unit for recharging the first rechargeable battery, and a first electronic switch for initiating the wireless charging transmitter to work automatically after the transmitting unit is induced electrically and generates charging triggering electromagnetic signals.

9. The electronic cigarette case as claimed in claim 8, wherein the wireless charging transmitter further comprises an external power socket for insertedly connecting with an external power, the external power socket is electrically connected with the first charging circuit unit and is also integrated on the transmitter circuit board.

10. The electronic cigarette case as claimed in claim 8, further comprising a switch device, wherein the switch device comprises a key installed at the case body and a control button correspondingly disposed on the transmitter circuit board, the key is capable of being pressed and controlled to electrically conduct with the transmitter circuit board so as to control the display unit to display quantity of electricity of the first rechargeable battery.

11. An electronic cigarette device, wherein the electronic cigarette device comprises the electronic cigarette case as claimed in claim 1, and at least one electronic cigarette accommodated in the electronic cigarette case, each of the at least one electronic cigarette comprises a second rechargeable battery, and a wireless charging receiver matching with the wireless charging transmitter for recharging the second rechargeable battery.

12. The electronic cigarette device as claimed in claim 11, wherein the wireless charging receiver comprises a reception unit for inducing with the transmitting unit to make the transmitting unit generating charging triggering electromagnetic signals therein and for receiving wireless charging electromagnetic signals, a receiving conversion circuit unit used for converting the wireless charging electromagnetic signals received from the reception unit into electrical currents, and a second charging circuit unit for electrically connecting with the second rechargeable battery to recharge the second rechargeable battery.

13. The electronic cigarette device as claimed in claim 11, wherein the reception unit is a magnetic induction reception coil, the reception unit is inserted in the electronic cigarette case and is relatively parallel to the transmitting unit.

14. The electronic cigarette device as claimed in claim 13, wherein an area of the reception unit is smaller than an area of the transmitting unit, and an orthogonal projection area of the reception unit falls within a range of the transmitting unit.

15. The electronic cigarette device as claimed in claim 11, wherein the at least one electronic cigarette comprises an inhaling rod and a power rod, the wireless charging receiver disposed in the power rod, a bottom of the power rod comprises a bottom cover and the wireless charging receiver is fixed in the bottom cover.
